(19) United States
(12) Patent Application Publication
(10) Pub. No.: US 2025/0007188 A1
(43) Pub. Date: Jan. 2, 2025

(54) CONNECTOR DEVICE CONFIGURED TO MITIGATE CROSSTALK

(71) Applicant: BELDEN CANADA ULC, SAINT-LAURENT (CA)

(72) Inventors: Virak SIEV, Montreal (CA); Michael BODZAY, Dollard-Des Ormeaux (CA)

(73) Assignee: BELDEN CANADA ULC, SAINT-LAURENT, QC (CA)

(21) Appl. No.: 18/760,989

(22) Filed: Jul. 1, 2024

Related U.S. Application Data
(60) Provisional application No. 63/524,128, filed on Jun. 29, 2023.

(51) Int. Cl. H01R 9/24

(52) U.S. Cl. CPC H01R 9/2425

(57) ABSTRACT

A connector device includes a plurality of connectors each configured to connect a conductor of a first cable to a conductor of a second cable. The connectors each include a body portion having conductor receiving portions each structurally configured to receive a conductor of one of the cables, a crosstalk mitigation portion configured to mitigate crosstalk, the crosstalk mitigation portion including a connection portion structurally configured to connect a first one of the conductors to a second one of the conductors, and the crosstalk mitigation portion is configured with a crosstalk mitigating shape configured to reduce a level of crosstalk to the cables.

### CROSS REFERENCE TO RELATED APPLICATION

This application claims the benefit of U.S. Provisional Application No. 63/524,128, filed Jun. 29, 2023, the disclosure of which is hereby incorporated by reference herein in its entirety.

### TECHNICAL FIELD

The present disclosure generally relates to a connector for connecting cables. More specifically, the disclosure relates to such a connector for connecting single pair ethernet cables that provides reduced crosstalk.

### BACKGROUND

Traditionally, terminal block connectors were designed to connect cables carrying power or control signals, but not data signals. Therefore, transmission parameters like crosstalk and balance that may occur with cables carrying data signals weren't considered during the design. In recent development, these connectors could also be used to connect cables carrying data signals (like with Single Pair Ethernet (SPE)) which may result in improper balance and excessive crosstalk.

FIG. 1 illustrates a typical terminal block connector 100. The terminal block connector 100 may be used to make an electrical connection between individual conductors. The terminal block connector 100 typically has a plastic body 102, receiving portions 104 for receiving the conductors to be connected, metallic plates 106, a bar 108 and screws 110. After inserting conductors to be connected in the receiving portions 104, the conductors may be in contact with the plates 106 and/or the bar 108 and the screws may be adjusted such that the conductors are pressed against the bar 110 to make an electrical connection between the conductors and the bar. The terminal block connectors 100 may be colored corresponding to the conductors to be connected.

In a typical SPE terminal block deployment, each corresponding conductor of an SPE cable is connected to its own terminal block 100. For example, as shown in FIG. 2, a first data conductor 210 may be connected to a red terminal block connector 204, a second data conductor 208 may be connected to a black terminal block connector 202, and a ground conductor 212 (if present) may be connected to a gray terminal block connector 206. In a typical deployment, the terminal block connectors may be placed or mounted directly adjacent to one another in a row as illustrated. As such, the gray terminal block (if present) would be placed either to the left or right of the two data terminal blocks.

The disposition of the conductors and the terminal block connectors next to each other may cause an imbalanced coupling within a pair of the SPE conductors, and between adjacent pairs of the SPE conductors, as shown in FIG. 3. Within a pair of the SPE conductors, the coupling is shown as the C1 and C2 capacitances, between the black conductor 302 and the shield conductor 306, and between the red conductor 304 and the shield conductor 306, respectively. Because the red terminal block connector is adjacent to the gray terminal block connector, the C2 capacitance is greater than the C1 capacitance by 3 dB or more (i.e., C2 is dominant). This inequivalence between C1 and C2 is the imbalanced coupling (or imbalanced noise) within a conductor pair.

Between adjacent pairs, coupling passes via the gray terminal block. The black terminal block of pair 2 is closer to the gray terminal block of pair 1, therefore the C3 capacitance is greater (i.e., dominant) than C4. The two dominant capacitances (C2 and C3) create an imbalanced coupling between adjacent pairs (i.e., Alien Crosstalk).

As illustrated in FIG. 4, between two pairs of the SPE conductors 402, 404 where each pair is without a ground conductor, the coupling is shown as the C1, C2, C3 and C4 capacitances. A similar imbalanced coupling exists between the adjacent pairs because C1≠C2, C2≠C3, C3≠C4, and C1≠C4. The imbalances described above will deteriorate the cabling system's ability to transmit data signals.

It may therefore be desirable to provide a terminal block connector that deduces a level of crosstalk.

### SUMMARY

According to embodiments of the disclosure, a connector device is configured to connect cables so at to mitigate crosstalk. The connector device includes a plurality of connectors each configured to connect a conductor of a first cable to a conductor of a second cable. Each of the connectors includes a body portion having conductor receiving portions each structurally configured to receive a conductor of one of the cables, and a crosstalk mitigation portion configured to mitigate crosstalk. The crosstalk mitigation portion includes a connection portion structurally configured to connect a first one of the conductors to a second one of the conductors. The crosstalk mitigation portion of a first one of the connectors connecting a first one of the cables is configured with a first crosstalk mitigating shape, the crosstalk mitigation portion of a second one of the connectors connecting a second one of the cables is configured with a second crosstalk reducing shape, the first crosstalk mitigating shape includes a first angled portion and the second crosstalk mitigating shape includes a second angled portion, and the first angled portion is angled at least 60 degrees different than the second angled portion to reduce a level of crosstalk of 3 dB or more.

A connector device is configured to connect cables so at to mitigate crosstalk. The connector device includes a plurality of connectors each configured to connect a conductor of a first cable to a conductor of a second cable, each of the connectors includes a body portion having conductor receiving portions each structurally configured to receive a conductor of one of the cables, a crosstalk mitigation portion configured to mitigate crosstalk, The crosstalk mitigation portion includes a connection portion structurally configured to connect a first one of the conductors to a second one of the conductors, and the crosstalk mitigation portion is configured with a crosstalk mitigating shape configured to reduce a level of crosstalk to the cables.

A connector device includes a plurality of connectors each configured to connect a conductor of a first cable to a conductor of a second cable. The connectors each include a body portion having conductor receiving portions each structurally configured to receive a conductor of one of the cables, a crosstalk mitigation portion configured to mitigate crosstalk, the crosstalk mitigation portion including a connection portion structurally configured to connect a first one of the conductors to a second one of the conductors, and the crosstalk mitigation portion is configured with a crosstalk mitigating shape configured to reduce a level of crosstalk to the cables.

### BRIEF DESCRIPTION OF THE DRAWINGS

Further advantages and features of the present disclosure will become apparent from the following detailed description and the accompanying drawings.

FIG. 1 illustrates a terminal block connector in accordance with various aspects of the disclosure.

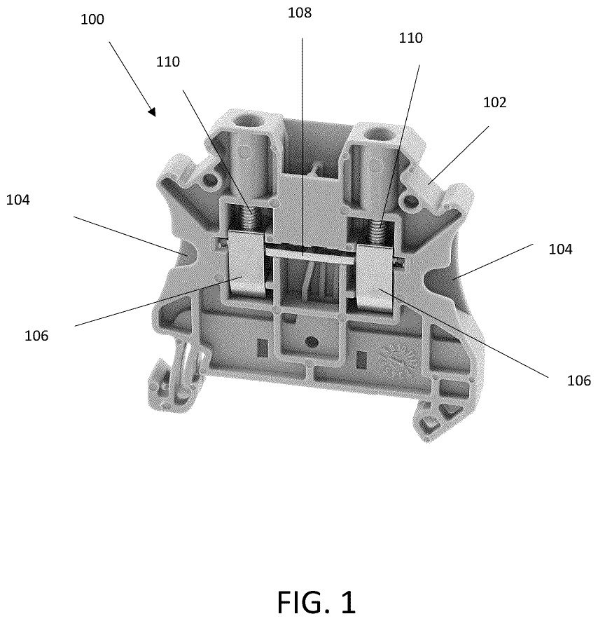

FIG. 2 illustrates terminal block connectors in accordance with various aspects of the disclosure.

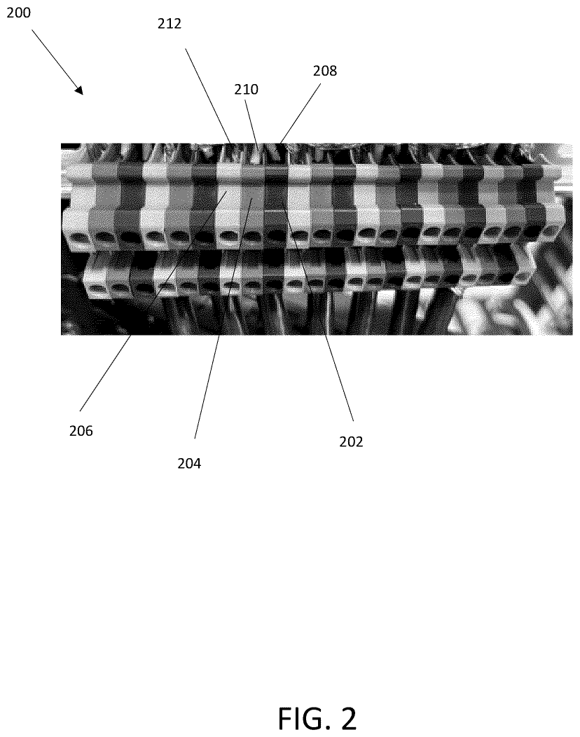

FIG. 3 illustrates imbalanced coupling of conductors in accordance with various aspects of the disclosure.

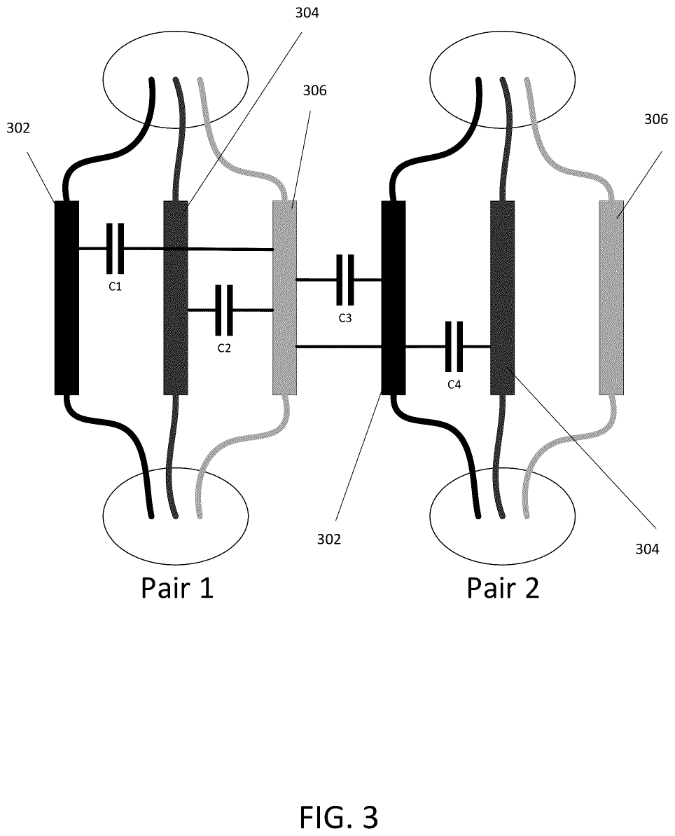

FIG. 4 illustrates imbalanced coupling of conductors in accordance with various aspects of the disclosure.

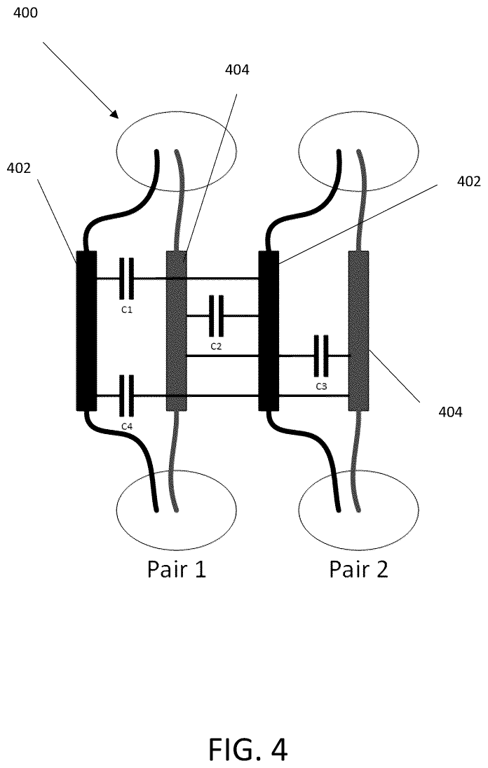

FIG. 5 illustrates a potential equalizing element in accordance with various aspects of the disclosure.

FIG. 6 illustrates a potential equalizing element in accordance with various aspects of the disclosure.

FIG. 7 illustrates a potential equalizing element in accordance with various aspects of the disclosure.

FIG. 8 illustrates a potential equalizing element in accordance with various aspects of the disclosure.

FIG. 9 illustrates a connector device in accordance with various aspects of the disclosure.

FIG. 10 illustrates a connector in accordance with various aspects of the disclosure.

FIG. 11 illustrates a connector in accordance with various aspects of the disclosure.

FIG. 12 illustrates a connector in accordance with various aspects of the disclosure.

FIG. 13 illustrates a graph of crosstalk at various frequencies in accordance with various aspects of the disclosure.

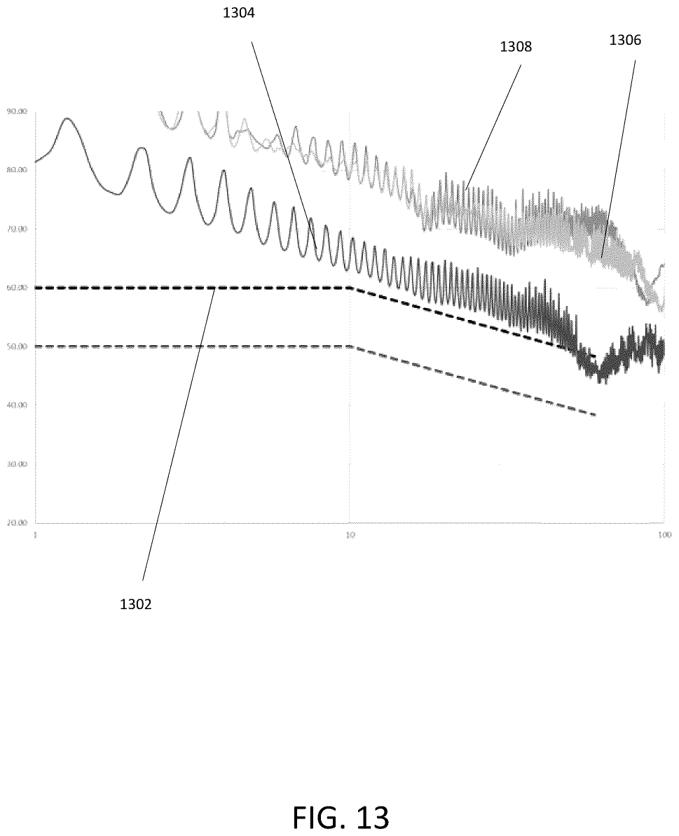

FIG. 14 illustrates a connector device in accordance with various aspects of the disclosure.

FIG. 15 illustrates a connector in accordance with various aspects of the disclosure.

FIG. 16 illustrates a connector device in accordance with various aspects of the disclosure.

FIG. 17 illustrates a connector device in accordance with various aspects of the disclosure.

FIG. 18 illustrates a connector device in accordance with various aspects of the disclosure.

FIG. 19 illustrates a connector device in accordance with various aspects of the disclosure.

### DETAILED DESCRIPTION

Reference will now be made in detail to presently preferred embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure. Furthermore, the terminology used herein is used only for the purpose of describing particular embodiments of the present disclosure and is not intended to be limiting in any way.

As used in the specification and the appended claims, the singular form “a,” “an,” and “the” include plural referents unless the context clearly indicates otherwise. For example, reference to a component in the singular is intended to also include a plurality of components.

There are multiple embodiments disclosed herein, all of which implement a form of the terminal block connector device with crosstalk mitigation as disclosed in related U.S. provisional patent application “TERMINAL BLOCK CONNECTOR DEVICE WITH BALANCED CROSSTALK” filed concurrently herewith. There are some unique features relative to standard terminal block connectors that may be used with any of the embodiments as follows:
The metal transmission plate would be replaced with a thinner metallic transmission pathway optimized for the power current and voltage ratings. This could be a lead frame type as in our RJ45 connectors, a Printed Circuit Board, 18 awg wires, or metal pins.
The screws used to create a compression contact between the conductors and the metal transmission plate may be replaced with other mechanical features capable of applying a compression force. This could be a spring, a cam, or protrusion in a secondary body portion. The compression mechanism shall be electrical isolated. This could be achieved by making them of a non-conductive material such as plastic, or by adding a non-conductive barrier layer between the screw and conductor.
The connection method between the conductors and the transmission pathway could be changed to an IDC style termination as opposed to a compression style termination. In this implementation the IDC would likely be formed as part of the lead frame that creates the electrical transmission pathways.
For dual or more input/output variants a single compression method for the input side and one for the output side could be used, i.e., one screw would apply the necessary force to some or all of the conductors on the input side for them to make proper electrical contact with their respective transmission pathways.

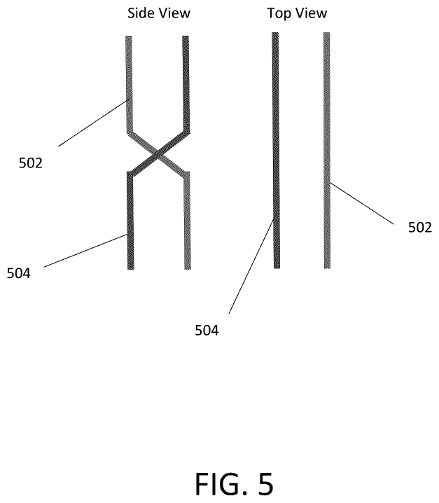

Specifically, the coupling balancing elements of various embodiments disclosed herein may be embodied within a terminal block connector and may include laying the two connection elements configured to include parallel paths to one another (either vertically, horizontally, or on some angle). For example, as illustrated in the top view of FIG. 5, the paths of the coupling balancing elements 502, 504 may be parallel and then cross at some mid-point such that the left is on the right and vice versa (or up/down, etc. as in the side view of FIG. 5). The terminal block connector may have two inputs and two outputs for the two data conductors of a SPE cable to be connected, and may optionally include a third input and output for a ground conductor if present. The internal configuration of the interconnection between input and output of the data ports is the coupling balancing elements which balances the crosstalk from adjacent terminal block connectors.

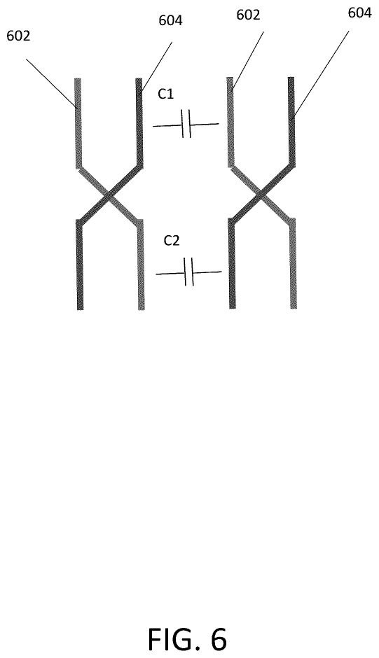

The parallel nature of the paths with the crossing is configured to balance the crosstalk such that capacitances C1=C2 representing crosstalk between adjacent pairs of SPE conductors. As illustrated in FIG. 6, the two connection elements 602, 604 are coupling balancing elements that are parallel in one plane but cross each other in another plane and function as compensation structure for balancing a crosstalk between the conductors.

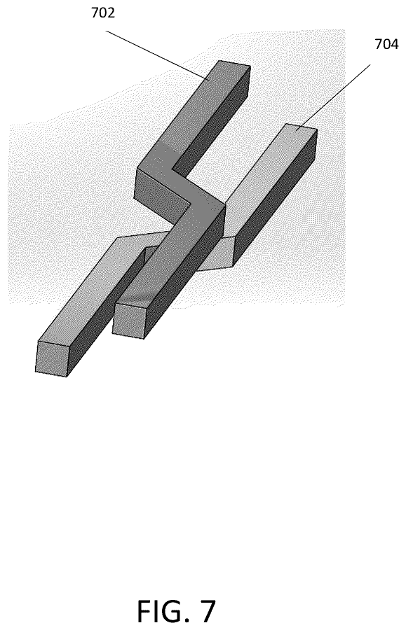

As illustrated in FIG. 7, coupling balancing elements 702, 704 are also configured to be parallel in a first plane but to cross in another plane. The crossing position may be at or near a center of the coupling balancing elements 702, 704. The two coupling balancing elements are parallel to one another in the plane from front to back but the paths are bent at some angle to one another. The angular nature of the path decreases the capacitive coupling between adjacent pathways because it is caused by parallel electrical elements. Thus, the angle mitigates the crosstalk between adjacent connectors.

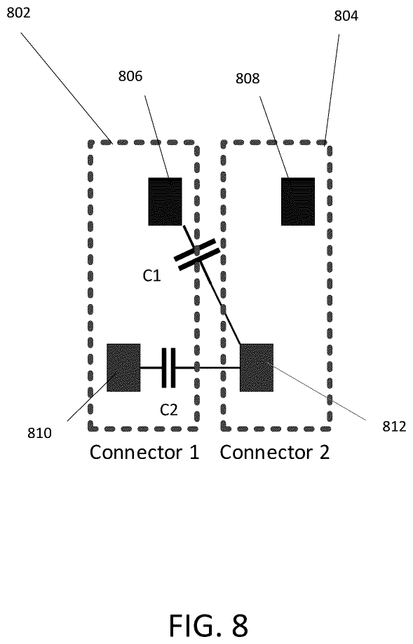

As illustrated in FIG. 8, terminal block connecting elements 802, 804 are positioned adjacent to each other with connecting elements for blue conductors 806, 808 and red conductors 810, 812. By offsetting the position of the pathways of the connecting elements within the terminal block connectors 802, 804, the distance between adjacent connector pathways is also increased. An increase in pathway distance decreases the coupling, thereby mitigating the crosstalk between adjacent terminal blocks. Additionally, the offset distance is optimized such that C1=C2. This is achieved by ensuring the distance between the red connecting element of the first terminal block connector and red connecting element of the second terminal block connector is equal to the distance between the blue connecting element of the first terminal block connector and the red connecting element of the second terminal block connector.

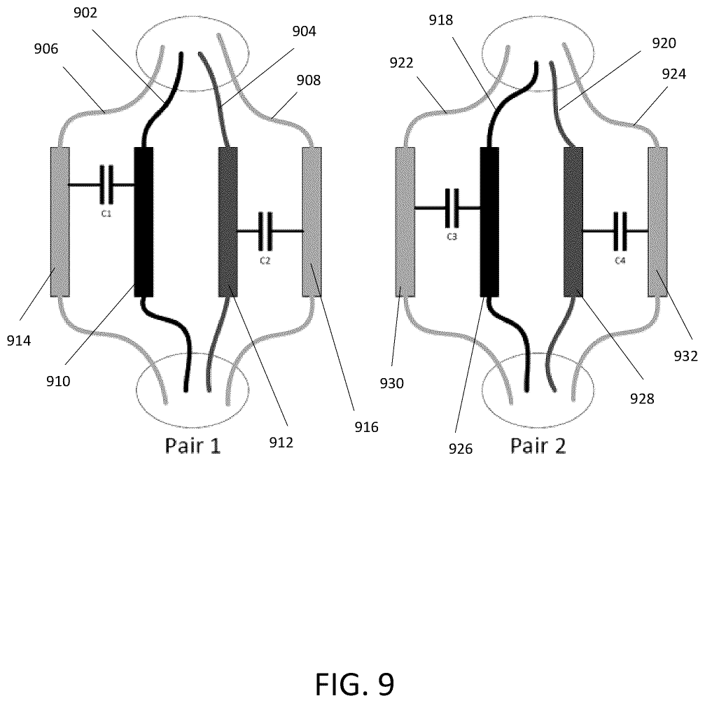

Some embodiments may include a terminal block connector with a single input and output as shown in FIG. 9. The connecting element on the transmission pathway within the terminal block connector is on an angle such that the input and output conductors are at a height offset relative to one another. The attachment mechanism of the terminal block connector to the DIN Rail would be symmetric such that it could be flipped so that terminal block connectors installed in a row would have their input ports alternate between up and down and likewise for the output port. Due to the angle of the connecting element on the transmission pathway, when two terminal block connectors are positioned side by side, where one is flipped relative to the other, the crosstalk is mitigated.

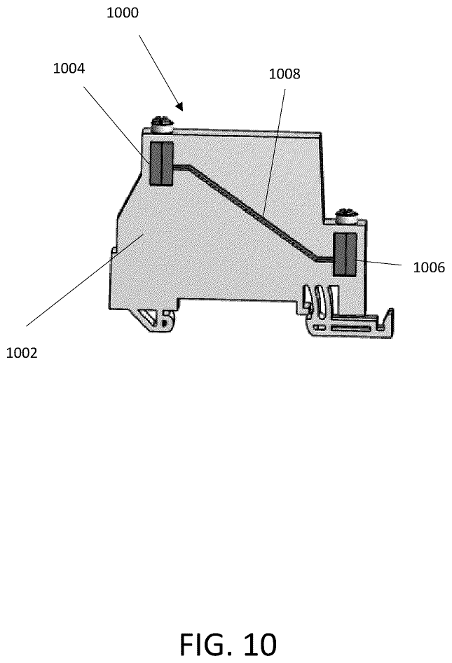

FIG. 10 illustrates a connector device 1000 in accordance with various embodiments. The connector device 1000 may include a connector 1002 configured to connect a conductor of a first cable via a first conductor receiving portion 1004 to a conductor of a second cable via a second conductor receiving portion 1006. The connector 1000 is configured to electrically connect the conductors of the cables within the connector device via a connection portion 1008. The connection portion 1008 may be a conductive material such as a metallic material.

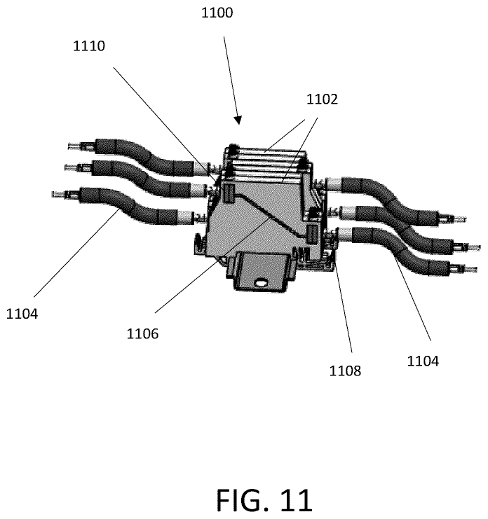

FIG. 11 illustrates a connector device 1100 in accordance with various embodiments. The connector device 1100 includes a plurality of connectors 1102, in this embodiment six connectors 1102, used to connect the conductors of six cables 1104. Each cable 1104 may have two data conductors 1108. The two data conductors 1108 of each cable 1104 are connected to the connectors 1102 of the connector device 110 at conductor receiving portions 1110. The connectors 1102 each include a connection portion 1106 that to one conductor 1108 of two different cables 1104 to connects the conductors 1108 to each other. As can be seen in FIG. 11, the connection portion 1106 may be configured to be angled at a downward angle from a left side to a right side in FIG. 11. The downward angle may be 30-60 degrees for example.

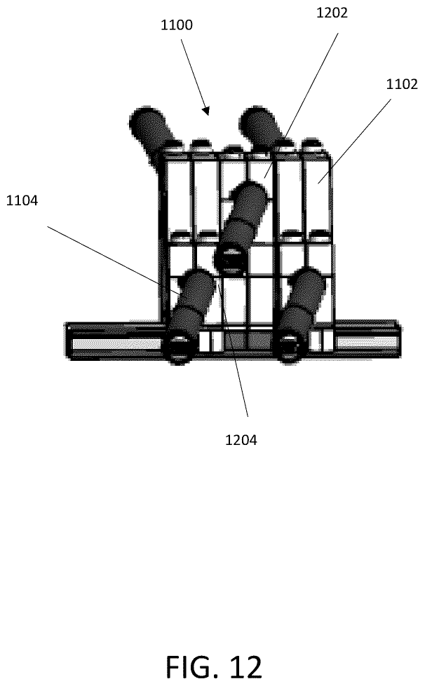

FIG. 12 illustrates a side view of the connector device 1100 of FIG. 11 connecting cables 1104. Each connector 1102 is used to connect a single data conductor 1108 of a cable 1104 to a data conductor 1108 of another cable 1104. The conductors 1108 of a first cable 1104 to the left in FIG. 12 enter the two leftmost connectors 1102 at a relatively low position 1204 on the connectors 1102, while the two conductors 1108 of a middle cable 1104 enter the middle two connectors 1102 at a relatively high position 1202. on the connectors 1102. The two conductors 1108 of the rightmost cable 1104 in FIG. 12 also enters the connectors 1102 at the relatively low position 1204.

In the embodiments of FIGS. 11 and 12, the geometry of the connection portions is configured such a way that when installed in a specific orientation the coupling from adjacent groups of connectors is reduced. There are two connection points, one higher relative to the other. The relative height difference is such that the angle of the connection portion that connects the two conductors is between 30 and 60 degrees. When used in groups to connect all of the conductors from one cable to another, all of the conductors from one cable will connect to the ‘low’ side and all of the conductors of the second cable will connect to the ‘high’ side. Adjacent groups of connectors used to connect other pairs of conductors from other cables mounted to the same DIN rail are flipped such that the connecting pairs viewed from one side alternate low, high, low, high. This configuration reduces the coupling in two ways. First the adjacent connecting cables and their respective connection points in the connectors are separated by a vertical distance from one another. This separation reduces the coupling because coupling is inversely correlated to distance (bigger distance, low coupling). Second, the alternating group configuration makes the center connection portions at a significant angle to one another between 60 and 120 degrees (optimal is perfectly perpendicular). This reduces the coupling because coupling requires parallel sections of conductive material.

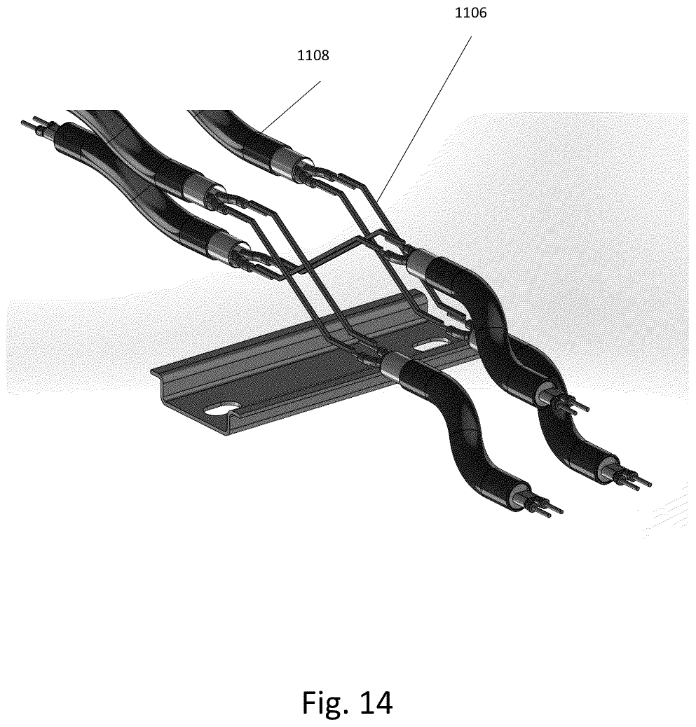

FIG. 14 illustrates the cables of FIGS. 11 and 12 with the connection portions 1106 having the rest of the connectors 1102 removed to illustrate positioning of the connection portions within the connectors 1102. The left and right cables 1108 have connection portions 1106 starting from a relatively high position from a left side of the figure and angle downward while the center cables 1108 starts from a relatively low position on the left side of FIG. 14 and angles upward. Utilizing this configuration of the connection portion alien crosstalk from adjacent connection portions is reduced because the connection portions are not positioned parallel to each other.

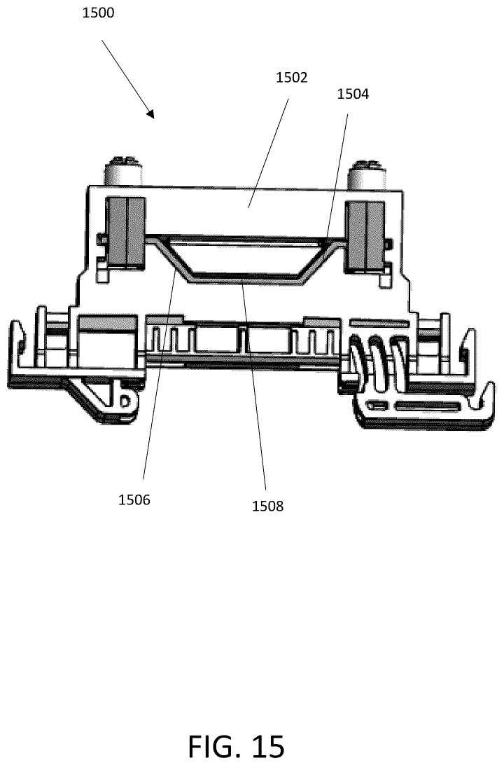

FIG. 15 illustrates another connector device 1500 that may be used with embodiments disclosed herein. The connector device 1500 may have a plurality of connectors 1502 and connection portions 1504. The connection portion 1504 may have end point starting at a same level, and may have a downwardly sloping potions 1506 and a flat portion 1508.

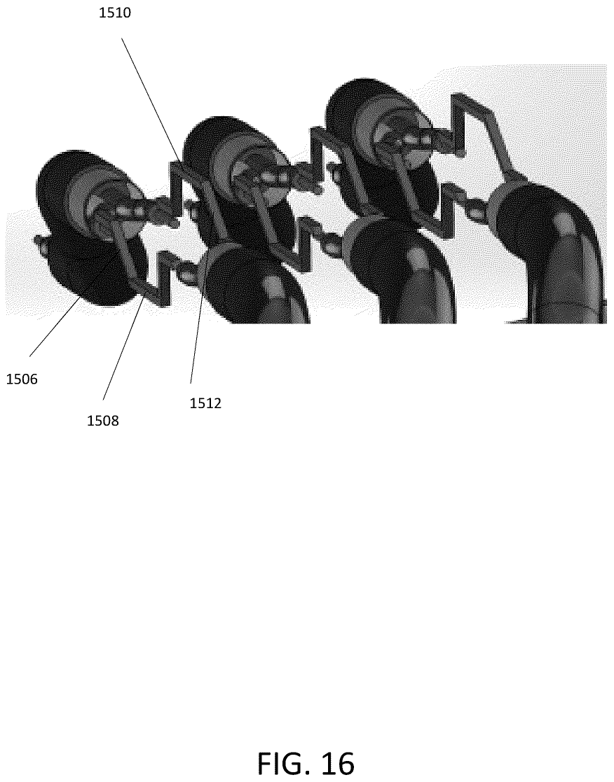

FIG. 16 illustrates the connector device 1500 with the housings of the connectors 1502 hidden for illustration of the connection portions. In this embodiment, the leftmost connection portion 1504 has downwardly sloping portions 1506 and the flat portion 1508. The second from leftmost connection portion has an upwardly sloping portion 1512 and a flat portion 1510. The remaining connection portions from left to right alternate with upwardly sloping and downwardly sloping portions. This positioning has the advantage of reducing crosstalk from the connection portions 1504 since the spacing of the connection portions is increased and they are not parallel.

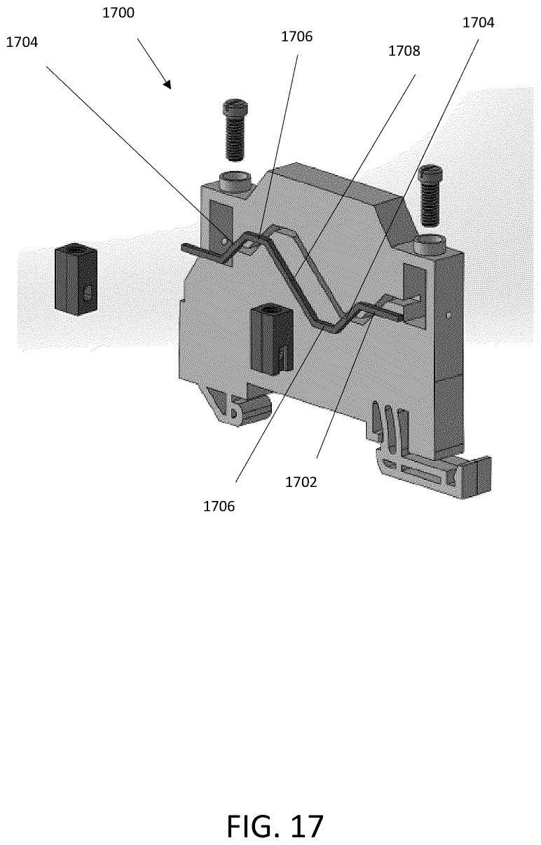

FIG. 17 illustrates another connector device 1700 in accordance with various embodiments. The connector device 1700 may include a connection portion 1702 for connection conductors of cables. The connection portion may have two upwardly sloping portions 1704, two flat portions 1706 and a downwardly sloping portion 1708.

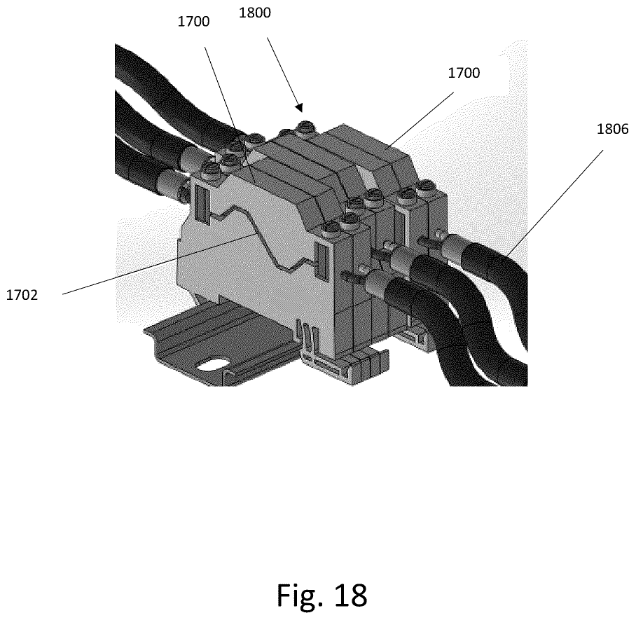

FIG. 18 illustrates a connector device 1800 in accordance with various embodiments. The connector device 1800 may include connectors 1802 for connecting cables 1806, each of the connectors 1802 having a connection portion 1702. Six connectors are used to connect the cables, but more or less connectors 1802 may be used depending on the number of cables 1806 to connect.

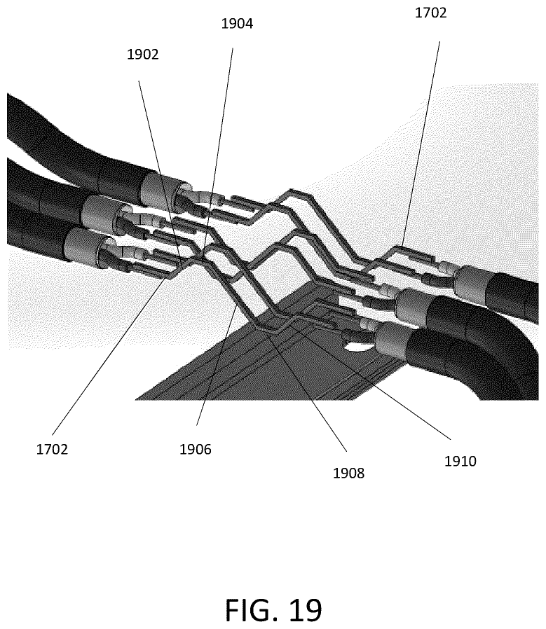

FIG. 19 illustrates the connector device 1800 with the housings of the connectors hidden for illustration of the connection portions 1702. In this embodiment, the two leftmost connection portions 1702 from left to right in the figure have upwardly sloping portions 1902, the flat portion 1904, the downwardly sloping portion 1906, the flat portion 1908 and the upwardly sloping portion 1910. The second from leftmost pair of connection portions have an opposite configuration, sloping in opposite directions. This can be achieved with an identical connector 1802 merely by flipping the connector 180 degrees. This results in the connection portions of adjacent cables being further spaced and not parallel, which improves on the reduction in alien crosstalk from adjacent cables and from the corresponding connection portions.

While multiple non-limiting embodiments have been presented in the foregoing detailed description, it should be appreciated that a vast number of variations exist. It should also be appreciated that the exemplary embodiment or exemplary embodiments are only examples, and are not intended to limit the scope, applicability, or configuration 1002 skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A connector device configured to connect cables so at to mitigate crosstalk, comprising:
a plurality of connectors each configured to connect a conductor of a first cable to a conductor of a second cable;
each of the connectors comprising:
a body portion having conductor receiving portions each structurally configured to receive a conductor of one of the cables; and
a crosstalk mitigation portion configured to mitigate crosstalk;
wherein the crosstalk mitigation portion comprises a connection portion structurally configured to connect a first one of the conductors to a second one of the conductors; and
wherein the crosstalk mitigation portion of a first one of the connectors connecting a first one of the cables is configured with a first crosstalk mitigating shape;
wherein the crosstalk mitigation portion of a second one of the connectors connecting a second one of the cables is configured with a second crosstalk reducing shape;
wherein the first crosstalk mitigating shape includes a first angled portion and the second crosstalk mitigating shape includes a second angled portion; and
wherein the first angled portion is angled at least 60 degrees different than the second angled portion to reduce a level of crosstalk of 3 dB or more.

2. The connector device of claim 1, wherein the first crosstalk mitigation portion of the first one of the connectors includes a first flat portion and the second crosstalk mitigation portion of the second one of the connectors includes a second flat portion and the first flat portion is vertically offset from the second flat portion.

3. The connector device of claim 1, wherein the first connector includes a first conductor receiving portion and the second connector includes a second conductor receiving portion, and the first conductor receiving portion is vertically offset from the second conductor receiving portion.

4. The connector device of claim 1, wherein the crosstalk mitigation portion of a first one of the connectors connecting a first one of the cables includes a first angled portion and a third angled portion and the crosstalk mitigation portion of a second one of the connectors connecting a second one of the cables includes a second angled portion and a fourth angled portion, the first angled portion is angled at least 60 degrees different than the second angled portion, and the third angled portion is angled at least 60 degrees different than the fourth angled portion to mitigate the crosstalk.

5. The connector device of claim 1, wherein the crosstalk mitigation portion comprises a conductive material.

6. The connector device of claim 1, wherein the cables are single pair ethernet cables.

7. A connector device configured to connect cables so at to mitigate crosstalk, comprising:
a plurality of connectors each configured to connect a conductor of a first cable to a conductor of a second cable;
each of the connectors comprising:
a body portion having conductor receiving portions each structurally configured to receive a conductor of one of the cables; and
a crosstalk mitigation portion configured to mitigate crosstalk;
wherein the crosstalk mitigation portion comprises a connection portion portion structurally configured to connect a first one of the conductors to a second one of the conductors;
wherein the crosstalk mitigation portion of a first one of the connectors connecting a first one of the cables is configured with a first crosstalk mitigating shape;
wherein the crosstalk mitigation portion of a second one of the connectors connecting a second one of the cables is configured with a second crosstalk mitigating shape; and
wherein the first crosstalk mitigating shape and the second crosstalk mitigating shape are configured to reduce a level of crosstalk of 3 dB or more.

8. The connector device according to claim 7, wherein the first crosstalk mitigating portion has a first crosstalk mitigating shape that includes a first angled portion and the second crosstalk mitigating portion includes second crosstalk mitigating shape includes a second angled portion; and
wherein the first angled portion is angled at least 60 degrees different than the second angled portion to reduce a level of crosstalk of 3 dB or more.

9. The connector device according to claim 7, wherein first crosstalk mitigation portion of the first one of the connectors includes a first flat portion and the second crosstalk mitigation portion of the second one of the connectors includes a second flat portion and the first flat portion is vertically offset from the second flat portion.

10. The connector device according to claim 7, wherein the first connector includes a first conductor receiving portion and the second connector includes a second conductor receiving portion, and the first conductor receiving portion is vertically offset from the second conductor receiving portion.

11. The connector device according to claim 7, wherein the crosstalk mitigation portion of a first one of the connectors connecting a first one of the cables includes a first angled portion and a third angled portion and the crosstalk mitigation portion of a second one of the connectors connecting a second one of the cables includes a second angled portion and a fourth angled portion, the first angled portion is angled at least 60 degrees different than the second angled portion, and the third angled portion is angled at least 60 degrees different than the fourth angled portion to mitigate the crosstalk.

12. The connector device according to claim 7, wherein the cables are single pair ethernet cables.

13. A connector device configured to connect cables so at to mitigate crosstalk, comprising:
a plurality of connectors each configured to connect a conductor of a first cable to a conductor of a second cable;
each of the connectors comprising:
a body portion having conductor receiving portions each structurally configured to receive a conductor of one of the cables; and
a crosstalk mitigation portion configured to mitigate crosstalk;
wherein the crosstalk mitigation portion comprises a connection portion structurally configured to connect a first one of the conductors to a second one of the conductors; and
wherein the crosstalk mitigation portion is configured with a crosstalk mitigating shape configured to reduce a level of crosstalk to the cables.

14. The connector device according to claim 13,
wherein the crosstalk mitigation portion of a first one of the connectors connecting a first one of the cables is configured with a first crosstalk mitigating shape; and
wherein the crosstalk mitigation portion of a second one of the connectors connecting a second one of the cables is configured with a second crosstalk mitigating shape.

15. The connector device according to claim 14, wherein the first crosstalk mitigating shape and the second crosstalk mitigating shape are configured to reduce a level of crosstalk of 3 dB or more.

16. The connector device according to claim 13, wherein a first one of the connectors includes a first conductor receiving portion and a second one of the connectors includes a second conductor receiving portion, and the first conductor receiving portion is vertically offset from the second conductor receiving portion.

17. The connector device according to claim 13, the first crosstalk mitigation portion of the first one of the connectors includes a first flat portion and the second crosstalk mitigation portion of the second one of the connectors includes a second flat portion and the first flat portion is vertically offset from the second flat portion.

18. The connector device according to claim 16, wherein the first connector includes a first conductor receiving portion and the second connector includes a second conductor receiving portion, and the first conductor receiving portion is vertically offset from the second conductor receiving portion.

19. The connector device according to claim 16, the crosstalk mitigation portion of a first one of the connectors connecting a first one of the cables includes a first angled portion and a third angled portion and the crosstalk mitigation portion of a second one of the connectors connecting a second one of the cables includes a second angled portion and a fourth angled portion, the first angled portion is angled at least 60 degrees different than the second angled portion, and the third angled portion is angled at least 60 degrees different than the fourth angled portion to mitigate the crosstalk.

20. The connector device according to claim 13, wherein the cables are single pair ethernet cables.
